(19) United States
(12) Patent Application Publication
(10) Pub. No.: US 2025/0112351 A1
(43) Pub. Date: Apr. 3, 2025

(54) MICROWAVE BAND-PASS FILTER WITH WIDE STOPBAND USING L-SHAPED SLOTTED MICROSTRIP RESONATORS

(71) Applicant: VIETTEL GROUP, Ha Noi City (VN)

(72) Inventors: LE HOANG LONG TAN, Ha Noi City (VN); MINH TUAN VU, Ha Noi City (VN); QUANG HUY DONG, Vu Thu District (VN); CAO QUYEN DANG, Ha Noi City (VN)

(73) Assignee: VIETTEL GROUP, Ha Noi City (VN)

(21) Appl. No.: 18/899,939

(22) Filed: Sep. 27, 2024

(30) Foreign Application Priority Data
Oct. 3, 2023 (VN) 1-2023-06886

(51) Int. Cl. H01P 1/20; H01P 3/08; H01P 7/08

(52) U.S. Cl. CPC H01P 1/20; H01P 3/081; H01P 7/082

(57) ABSTRACT

A wide-stopband high-frequency band-pass filter using L-shaped slotted microstrip resonators, where the filter's nearest spurious frequency is approximately 3.5 times the center frequency f₀. The filter consists of the following components: dielectric substrate, copper layer, L-shaped slotted microstrip resonators, 50-Ohm impedance microstrip lines, and high-frequency connectors. The microstrip filter is implemented on a two-layer printed circuit board, designed by resonantly coupling the L-shaped slotted microstrip lines. It features a compact size and a wide stopband using a completely new resonant pattern, the L-shaped slotted microstrip line, which creates a filter with a wide stopband of approximately 2.5 f₀. This design is significantly smaller than conventional filters at the same frequency that have a narrower stopband. The input and output high-frequency connectors are directly connected to the resonator through inductive or capacitive coupling via the 50-Ohm impedance line.

### FIELD OF THE INVENTION

The invention refers to a wide-stopband band-pass high-frequency filter using L-shaped slotted microstrip resonators, with the spurious response of filter raised at approximately 3.5 times the filter frequency f₀. Specifically, the microstrip filter is implemented on a two-layer printed circuit, designed by coupling the resonances of the L-shaped slotted microstrip lines.

### BACKGROUND OF THE INVENTION

The filter is a crucial component in all signal transmitting and receiving devices, responsible for allowing or blocking specific signal components. There are various types of filters: digital filters, analog filters, high-frequency filters, etc. Filters can be used in transmitters to eliminate harmonics and self-generated noise in the transmitted signal, in power systems to remove electromagnetic interference, or in receivers to block unwanted signal components from external sources that are absorbed by the antenna, causing interference in the signal processing, or to reduce the saturation effect on the receiver's input amplifier caused by interfering transmitters.

The high-frequency filter can be placed in the transmission or reception path. The high-frequency reception filter is typically positioned at the input of the receiver, right after the antenna, while the high-frequency transmission filter is usually placed at the output of the power amplifier, just before the antenna, typically as a band-pass or low-pass filter as described in FIG. 1. Microwave band-pass filters are typically designed using distributed elements with a filter frequency f₀, which often exhibit undesirable spurious performance at frequencies 2f₀, 3f₀, . . . nf₀, as described in FIGS. 2 and 3. Therefore, standard filters cannot eliminate harmonics and interferences if they appear in these frequency ranges. Additionally, one issue with these filters is their sizes; the lower the frequency, the larger the filter size, which poses a significant challenge when integrating microwave filters at low frequencies (such as L or S bands) into multi-band transmission and reception systems. To suppress the undesirable spurious responses, multi-stage filters designed to extend the stopband can be used. However, this method increases the size of the filter and signal losses at high-frequency bands. Hence, finding a resonant structure that is compact in size with a wide stopband when coupled will optimize the aforementioned issues.

Therefore, the authors have proposed a band-pass filter using L-shaped slotted resonators with a wide stopband. The size of this type of filter is compact, and it can be designed as individual filter modules or as filter arrays to be used as components soldered directly onto the printed circuit board when integrated into transmission and reception systems.

### SUMMARY OF THE INVENTION

The purpose of the invention is to propose a compact band-pass filter with a wide stopband using a completely new resonant model: L-shaped slotted microstrip lines. This filter achieves a wide stopband of approximately 2.5 f₀ and is significantly smaller in size compared to conventional filters at the same frequency that have a narrower stopband.

From the first aspect, the first resonant frequency of conventional microstrip lines has a wavelength that is four times the size of the microstrip line. Therefore, as the resonant frequency decreases, the physical size of the microstrip line increases accordingly. To address this, L-shaped slotted microstrip lines is proposed to increase the electrical size while maintaining the physical dimensions of the resonant line.

From the second aspect, in a conventional filter structure, each resonant element that is coupled into the filter has its resonant frequency, which contributes to the passband of the filter. To achieve a band-pass filter, the more resonant frequencies that contribute to the passband, i.e., the higher the order of the filter, the more resonant elements are needed. While the primary resonant frequencies of the resonant lines, when coupled, form the passband of the filter, the secondary ones generate spurious passbands. Therefore, to create a filter with a wide stopband, the authors proposed a type of resonant line where the distance between the primary resonant frequency and the secondary resonant frequency is much larger than usual. As a result, when the filter is synthesized by coupling these resonant lines, a filter with a wide stopband is achieved.

### BRIEF DESCRIPTION OF THE DRAWINGS

FIG. 1 is a diagram illustrating the basic block diagram of a transmitter-receiver line, in which the high-frequency filter is used to eliminate harmonics and noise from the transmitted signal;

FIG. 2 illustrates the basic single microstrip filter, also known as the edge coupling filter;

FIG. 3 illustrates the frequency response of the filter shown in FIG. 2, clearly showing the spurious frequencies of the filter appearing close to the filter's passband;

FIG. 4 depicts the resonant frequencies appearing close to each other at intervals of f₀ for the resonator, which is simply a basic microstrip line, the simulated value is obtained by evaluating the insertion loss of the resonator with loose coupling at the input and output;

FIG. 5 depicts the resonant frequencies appearing further apart for the resonator using the L-shaped slotted microstrip line, the simulated value is obtained by evaluating the insertion loss of the resonator with loose coupling at the input and output;

FIG. 6 illustrates the structure of the L-shaped slotted microstrip resonator;

FIG. 7 is a schematic diagram of the equivalent circuit of the L-shaped slotted microstrip line, where the L-shaped slot creates internal capacitive and inductive coupling within the microstrip line;

FIG. 8 illustrates the edge capacitive coupling between two L-shaped slotted microstrip line;

FIG. 9 illustrates the frequency response of the coupling between two L-shaped slotted microstrip lines, as described in FIG. 8;

FIG. 10 illustrates the structure of a wideband filter using four L-shaped slotted microstrip lines; and

FIG. 11 illustrates the performance results of the filter, demonstrating that the stopband is significantly wider compared to conventional filters.

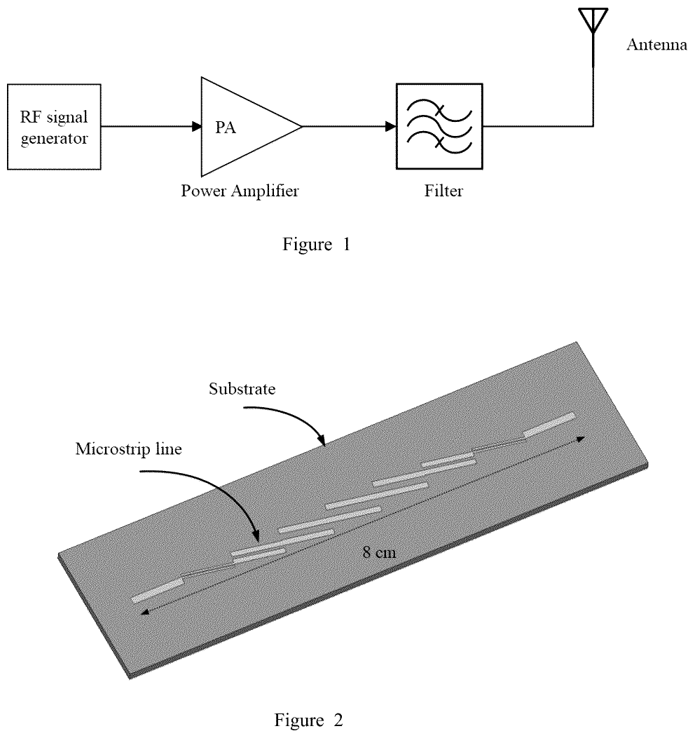

### DETAILED DESCRIPTION

The invention described in detail below is based on the accompanying illustrations, which are intended to illustrate the embodiments of the invention without limiting the scope of the patent protection.

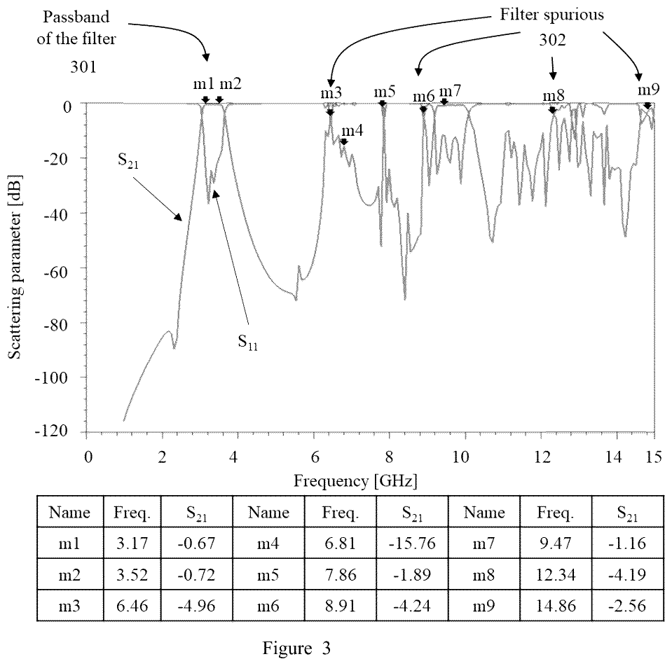

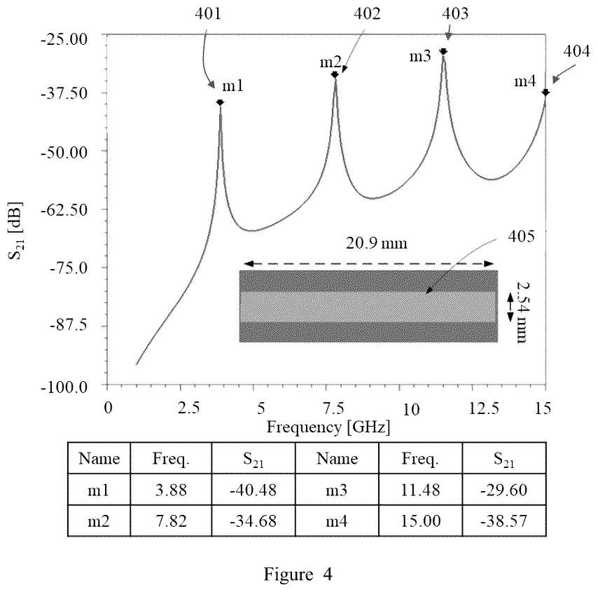

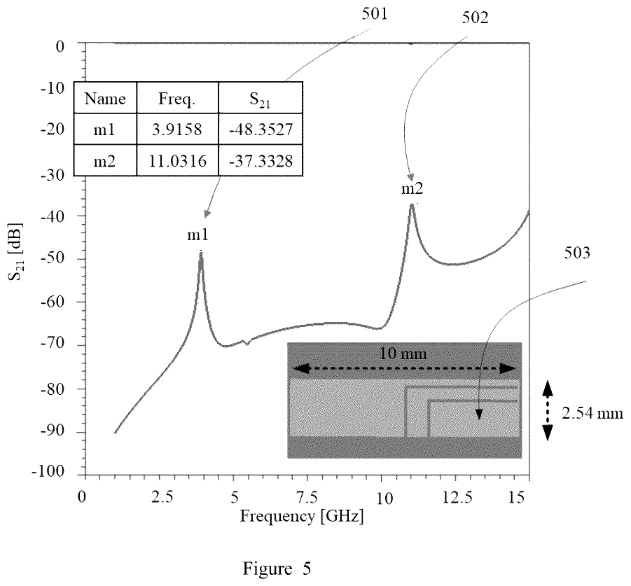

To achieve the objective of the invention, the wide-stopband high-frequency band-pass filter using L-shaped slotted microstrip resonators includes the following components: a dielectric substrate 1003; a copper layer 1004; L-shaped slotted microstrip resonators 1002; a 50-Ohm impedance microstrip line 1005; and an RF connector 1001. Specifically, the copper layer 1004 is electrically grounded, the dielectric substrate 1003 is placed in the middle, and the L-shaped slotted microstrip resonators 1002 are positioned on top
The dielectric substrate 1003 is made of Roger 5880 or Roger 4003C material with very low dielectric loss. Roger 5880 is typically used when the filter requires low loss, although it costs significantly more compared to Roger 4003C. The dielectric substrate serves as the wave propagation medium, so with materials having lower dielectric loss, the filter's loss is reduced accordingly
The L-shaped slotted microstrip resonators 1002 are thin copper metal plates, with standard thicknesses such as 0.017 mm, 0.035 mm, etc. These microstrip resonators, combined with the dielectric substrate and copper layer, form a wave propagation line with an impedance of 50 Ohms
The L-shaped slotted microstrip resonators 1002, due to their special structure, also push the filter's spurious frequency regions farther away. Observing FIGS. 4 and 5, the resonant frequency of a conventional microstrip resonator 405 and an L-shaped slotted microstrip resonator 503 are aimed at designing a filter for the 3.9 GHz band. FIG. 4 shows the resonant frequencies of a conventional microstrip resonator. Besides the fundamental resonant frequency of 3.9 GHz 401, there are also resonant frequencies at 7.8 GHz 402, 11.5 GHz 403, 15 GHz 404, and so on, approximately n times the fundamental frequency (n=2, 3, 4 . . . ). These resonant frequencies contribute to the spurious response characteristics 302 of the filter as described in FIG. 3 when synthesizing the band-pass filter 301. In contrast, FIG. 5 shows that the L-shaped slotted microstrip resonator, aside from resonating at the fundamental frequency of 3.9 GHz 501, has spurious resonant frequencies appearing only at 11 GHz 502, approximately 3 times the fundamental frequency. Due to this characteristic, when designing a filter by coupling L-shaped slotted resonators, the distance between the passband and the spurious frequency regions of the filter is increased, effectively widening the stopband
The RF connector 1001 is the component that connects the filter to other devices. The chosen connector is rated for frequencies above 26.5 GHz, complies with the SMP connection standard, and has an impedance of 50 Ohms to match the 50-Ohm standard of other devices

Furthermore, with the same fundamental resonant frequency f₀, the physical length of the L-shaped slotted microstrip line is much smaller compared to the conventional microstrip line. Specifically, for a resonant frequency of 3.9 GHz, the conventional microstrip line 405 measures 20.9×2.54 mm, while the individual L-shaped slotted microstrip line 503 measures only half, at 10×2.54 mm.

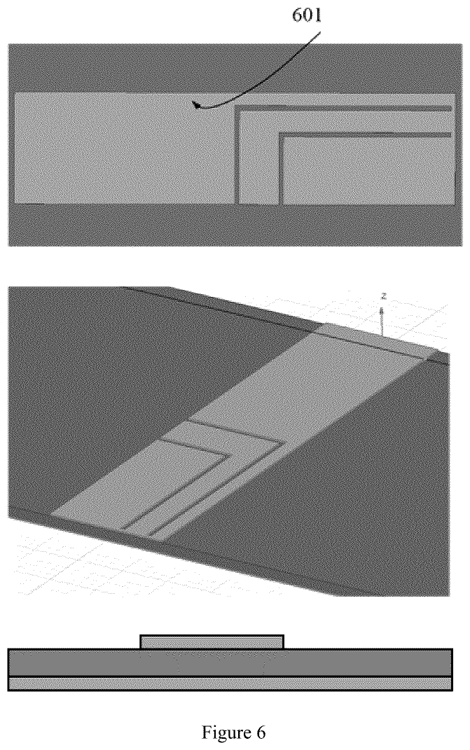

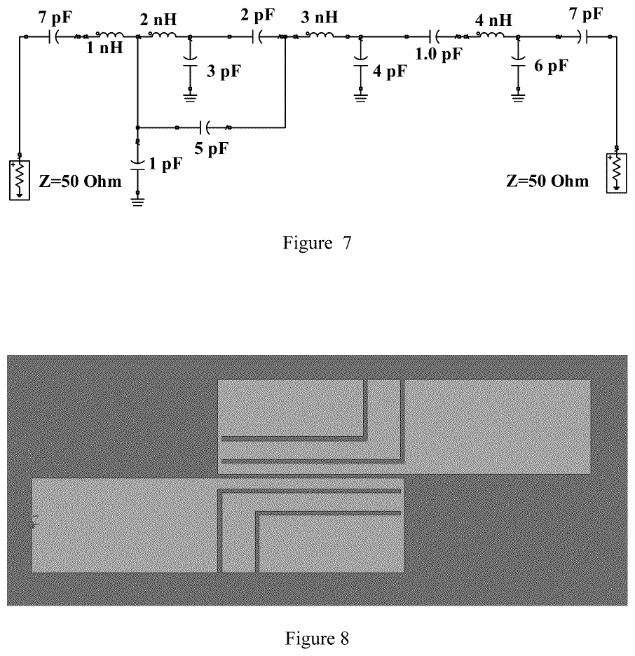

Observing an L-shaped slotted microstrip resonator when standing alone as described in FIG. 6, it is essentially a single microstrip resonator 601. The L-shaped slots are introduced to increase the electrical length, which reduces the resonant frequency of the microstrip line compared to a microstrip line of the same size. Additionally, the slots create poles and zeros to increase the filter's slope and eliminate second-order spurious frequencies of the filter. Referring to FIG. 7, these resonators, combined with the reference ground layer, form a network of capacitance and inductance values at high frequencies, connecting to create a RF microwave filter.

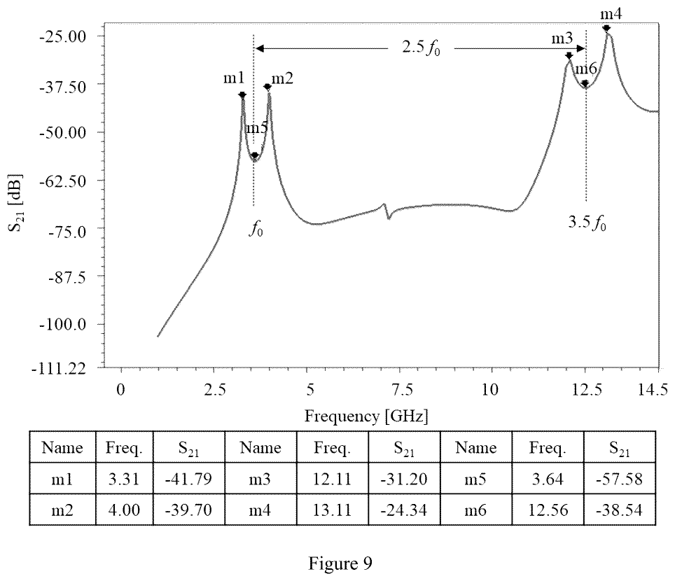

Combining these individual L-shaped slotted resonators 601 in various ways, such as edge coupling, face coupling, or direct inductive coupling with appropriate coupling coefficients, will create band-pass filters with desired frequency characteristics. FIG. 8 illustrates edge coupling between two individual L-shaped slotted resonators 601. With loose coupling, the coupling characteristics are shown in FIG. 9. The S₂₁ frequency response clearly demonstrates two resonant-frequency regions that form filters with a separation of 2.5f₀. Filters based on single L-shaped slotted resonators 601 are commonly designed using the coupling matrix method.

In this invention, filters are created using L-shaped microstrip resonators. Referring to FIG. 11, these resonators have resonant frequencies within the filter's bandwidth and are adjusted to couple with each other so that their combined coupling creates a flat passband with uniformity within the band of less than 1 dB.

### THE EFFECTIVENESS OF THE INVENTION

Compared to traditional resonators, the L-shaped slotted microstrip resonator offers a more compact design while significantly expanding the stopband. Traditional resonators typically have a narrower stopband, whereas the L-shaped slotted microstrip resonator achieves a stopband of approximately 2.5f₀, providing superior performance in terms of filtering out unwanted frequencies. Additionally, the innovative design allows for better control and flexibility in adjusting the resonant frequency, unlike traditional approaches that are limited in tuning capabilities.

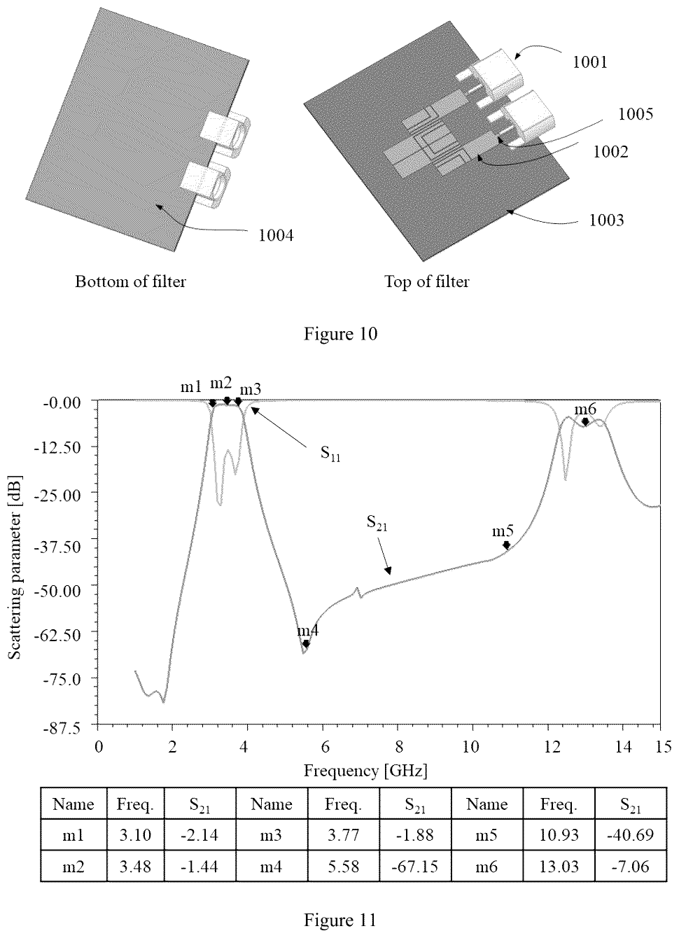

To enhance the understanding of the effectiveness of wide-stopband filters using L-shaped slotted microstrip lines, the authors have proposed a filter configuration with four individual L-shaped slotted microstrip lines, resonantly coupled as shown in FIG. 10. In this design, the microstrip lines are coupled using a capacitive coupling technique in an edge-coupling configuration. The filter operates over a bandwidth of 3.1 GHz to 3.7 GHz, with spurious responses occurring at a frequency of 13 GHz, which is significantly distant from the center frequency. The frequency response characteristics of the filter are illustrated in FIG. 11.

1. A wide-stopband high-frequency band-pass filter using L-shaped slotted microstrip resonators consists of the following components: a dielectric substrate, a copper layer, L-shaped slotted microstrip resonators, 50 Ohm microstrip impedance lines, and high-frequency connectors, wherein:
the L-shaped slotted microstrip resonators consist of thin metal sheets with standard thicknesses typically 0.017 mm, 0.035 mm, etc., cut in an L-shape, and can be continuously connected in various coupling configurations;
the dielectric substrate is an insulating material used to mount the 50 Ohm microstrip impedance line and microstrip resonator on the top and bottom, keeping them at a fixed distance, the best material is Roger 5880, which has a very low dielectric loss tangent (TD=0.0023), a thin thickness of 0.254 mm, and a dielectric constant ε=2.2;
the 50-Ohm microstrip impedance lines are mounted on the dielectric substrate and connects the high-frequency connectors and resonators;
the high-frequency connectors are components that connects the wide-stopband high-frequency bandpass filter to other devices, and operate at frequencies up to 26.5 GHz, following the SMP or SMA standard, with 50 Ohm impedance, and having a function is to convert high-frequency signal transmission from Quasi-TEM wave mode to coaxial mode, the input and output high-frequency connectors are directly connected to the resonators through inductive or capacitive coupling via the 50 Ohm microstrip impedance line.

2. The wide-stopband high-frequency band-pass filter using an L-shaped slotted microstrip resonators according to claim 1, in which: the L-shaped slotted microstrip resonator is a microstrip line that is cut to form an L-shaped slot; the resonant frequency can be adjusted by changing the respective dimensions of each microstrip line; the filter bandwidth and the distance from a spurious frequency band to the main passband can be altered by adjusting a width and size of the L-shaped slot, the L-shaped slotted microstrip resonators can be coupled together using capacitive coupling, inductive coupling (including edge coupling or face coupling . . . ), to form filters.
